(19) United States
(12) Patent Application Publication
(10) Pub. No.: US 2010/0192034 A1
(43) Pub. Date: Jul. 29, 2010

(54) Termination-Specifying ARQ protocol for Wireless Communications

(75) Inventors: Harshal S. Chhaya, Plano, TX (US); Ramanuja Vedantham, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/361,709

(22) Filed: Jan. 29, 2009

(51) Int. Cl. H04L 1/08; G06F 11/14

(52) U.S. Cl. 714/748; 714/E11.131

(57) ABSTRACT

A method of performing wireless communications. The method receives at a receiving unit a sequence of data blocks from a transmitting unit. The method also identifies at the receiving unit a first invalid sequential data block in the sequence. The method also communicates from the receiving unit a wireless message to the transmitting unit for provoking the transmitting unit to re-transmit a portion of the sequence of data blocks. The wireless message comprises a first field and a second field. The first field is for identifying the first invalid sequential data block. The second field is for identifying a last data block, from the sequence of data blocks, to which the wireless message applies.

### CROSS-REFERENCES TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

The preferred embodiments are in the field of wireless communications and are more specifically directed to automatic repeat requests from a receiving unit to indicate to a transmitting unit to re-transmit a number of data blocks that were not properly received by the receiving unit.

Advances in wireless communication technology, especially in recent years, have greatly improved not only the performance (i.e., data rate for a given error rate) at which wireless communications can be carried out, but also have enabled the realization of additional functions and services by way of wireless communications. For example, wireless broadband communication in metro area networks is now becoming commonplace. An example of one type of wide area wireless network communications is referred to as “WiMAX”, corresponding to communications carried out under IEEE Standard for Local and metropolitan area networks, Part 16: Air Interface for Fixed Broadband Wireless Access Systems (IEEE Standard 802.16-2004, and all subsequent revisions). Of course, wireless local area networks (WLAN) are also now becoming commonplace and are capable of carrying traffic at very high data rates (e.g., 100 Mbit/sec).

Networks operating under the WiMAX standard, for example, are capable of carrying out multiple types of communications. These multiple communications “services” are typically supported by modern wireless devices, including laptop computers equipped with WiMAX network adapters, palm top computers or highly capable personal digital assistants (PDAs), and modem “smartphones” that support data services. As known in the art, these modern wireless devices and systems, communicating via a WiMAX or other metro or wider area wireless network, support multiple simultaneous wireless communications sessions. Different types of such communications can have different constraints and requirements. For example, one class of such communications that can be carried out under WiMAX is voice telephony, by way of the well-known Voice over Internet Protocol (VoIP) service. VoIP communications involve constraints on the timeliness of the communications (i.e., so that a sensible back-and-forth conversation can be carried out), but can tolerate a relatively high error rate. In contrast, email services, and web browsing services over the Internet, involve less stringent time constraints, but can have higher error rate requirements.

Physically, a WiMAX metro area network is realized via base stations deployed within the physical service area with some frequency (e.g., on the order of a base station deployed every mile, to every several miles), similar to cellular telephone base stations and towers. A given base station is capable of communicating with nearby wireless client devices, typically referred to as “subscriber stations”, or often as “mobile stations” considering that these devices are typically portable computing and communications devices such as laptop or palmtop computers, smartphones, and the like. Each of the traffic flows between a mobile station and a base station is typically referred to as a “service flow”, in the context of WiMAX communications. For example, a VoIP call is carried out over one service flow, an email session is carried out over another service flow, and each web browsing session is carried out over another service flow. As evident from this discussion, multiple service flows may be carried out simultaneously between a mobile station and a base station; indeed, communications in each direction (e.g., uplink to the base station and downlink from the base station) are typically considered separate service flows, such that bidirectional communications in an interactive web session, for example, typically constitutes two service flows.

Various communications standards include and define an automatic repeat request (ARQ) sub-protocol under which a receiving station, after receiving a sequence of blocks (or interchangeably referred to as “packets”) of data, provides feedback to the transmitting station if blocks of that data were not properly received. Thus, in a given service flow, the receiving station provides feedback to the transmitting station, and from the above discussion of service flows note that for a given service flow, the receiving station may be the base station while the transmitting station is the subscriber/mobile station, or conversely for a given service flow, the receiving station may be the subscriber/mobile station while the transmitting station is the base station. In any event, the ARQ feedback specifies, for erroneous or lost data blocks, various message formats for the feedback messages that when received by the transmitting station, cause that station to re-transmit the improperly received (or lost) data blocks. Thus, by way of example but without limitation to the preferred embodiments detailed later, for conventional communications under the IEEE 802.16 standard, there are four different types of ARQ formats: (i) Selective ACK; (ii) Cumulative ACK; (iii) Cumulative with Selective ACK; and (iv) Cumulative ACK with Block Sequence ACK. Each of these is known in the art, but each is also described below for sake of background and for sake of contrast to the preferred embodiments detailed later.

In the Selective ACK ARQ format, a receiving station transmits a feedback message to a transmitting station that includes one or more (up to four) 16-bit bitmaps, where each bit in the bitmap corresponds to a respective block of data received by the receiving station and indicates, by the binary map value, whether the block was received either acceptably or in error. For example, if the binary value of 1 indicates an acceptable data block, then the binary value of 0 indicates an unacceptable (i.e., in error) data block, where at least the latter therefore is to be re-transmitted by the transmitting station once it receives and comprehends the feedback ARQ message. Using these conventions and by way of example, therefore, a 16-bit Selective ACK bitmap of 1111000011110000 indicates from the receiving station to the transmitting station that in the 16 blocks of data it received, the first set of four data blocks was acceptable, the second set of four data blocks was in error, the third set of four data blocks was acceptable, and the fourth set of four data blocks was in error. Thus, in response to the message, the transmitting station may re-transmit the erroneous data blocks (i.e., the second and fourth set of blocks).

In the Cumulative ACK ARQ format, a receiving station transmits a feedback message to a transmitting station that includes an identifier (e.g., sequence number) of the last data block that was satisfactorily received in a sequence of blocks. Thus, in response to the message, the transmitting station may re-transmit the sequence starting from the next block following the identified-erroneous received data block. Note that the Cumulative ACK ARQ format has at least one drawback if used in sequences that include a burst of erroneously-received data blocks in the middle of otherwise properly received data blocks. More specifically, then, consider the use of the Cumulative ACK ARQ format in a case for a sequence of 100 blocks, where the first 10 blocks are received accurately, the next 5 blocks are received in error, and the remaining 85 blocks are received accurately; in this case, then the Cumulative ACK ARQ would indicate the last error-free block before an error occurred, that is, then 10^{th} block in the example sequence. In response, therefore, the transmitting station is caused to re-transmit the latter 90 blocks of data in the sequence, even though the latter 85 of those already were transmitted and received without errors. Thus, data bandwidth is consumed in the re-transmitting of that data.

In the Cumulative with Selective ACK format, a receiving station transmits a feedback message to a transmitting station that includes both: (1) an identifier (e.g., sequence number) of the last data block that was satisfactorily received in a sequence of blocks; and (2) one or more (up to four) 16-bit bitmaps, where each bit in a bitmap corresponds to a respective block of data received by the receiving station and indicates, by the binary value, whether the block was either acceptable or in error, where these described 16 data blocks follow the last identified block in item (1), above. In other words, this format combines the two formats detailed above. Note that the Cumulative with Selective ACK format has at least one drawback if it is used in a sequence where the error block is early in the sequence in that the bitmap therefore will only characterize up to the next 64 blocks following the last of the properly-received blocks in the sequence.

In the Cumulative ACK with Block Sequence ACK format, a receiving station transmits a feedback message to a transmitting station that includes an indication of the sequence number of the last in sequence correctly received block and up to 4 ACK Maps. Each ACK map includes an indication of the type of sequence used and either 14 bits in a 2 sequence variant or 15 bits in a 3 sequence variant. For either variant, these bits includes a Sequence Ack Map (“SAM”), where the Map is 2 bits for the 2 sequence variant and the Map is 3 bits for the 3 sequence variant. The state of each bit in the map indicates that a sequential number of blocks, corresponding to that bit, were received either as all valid (i.e., without error) or all invalid. For example, a binary value of 0 indicates that a corresponding sequential number of blocks were invalid, and a binary value of 1 indicates that a corresponding sequential number of blocks were valid. Thus, for the 2 sequence variant, a SAM of 01 indicates that a first sequence length SL₁ of sequential blocks, corresponding to the first SAM bit value of 0, were received as invalid, and a second sequence length SL₂ of sequential blocks, corresponding to the second SAM bit value of 1, were received as valid. Note that the first and second sequence lengths SL₁ and SL₂ are also included in the message format. Particularly, in addition to the SAM, the remaining 12 bits in the message identify two six-bit binary numbers, where each binary number thereby indicates the values of SL₁ and SL₂ (i.e., a value up to 31 due to the six bits). Continuing the previous example with the SAM of 01, assume also that in the remaining 12 bits the first six bits are 000111 (i.e., decimal 7) and the second six bits are 010011 (i.e., decimal 19). Thus, these values respectively indicate that SL₁=7 and SL₂=19. Accordingly, in combination with the SAM, this message would indicate that the receiver received a sequence of data blocks wherein the first 7 blocks were invalid while the next 19 blocks were valid. The 3 sequence variant of this format is similar, but its SAM includes three bits, each corresponding to a respective 4-bit sequence length SL₁, SL₂, and SL₃ in the remaining 12 bits. Thus, for the 3 sequence variant, the remaining 12 bits in the message provide three 4-bit numbers that each respectively indicate one of the values of SL₁, SL₂, and SL₃. Consider then an example of a SAM of 010, and assume also that in the remaining 12 bits the first four bits are 0011 (i.e., decimal 3, that is, SL₁=3), the second four bits are 1001 (i.e., decimal 9, that is, SL₂=9), and the third four bits are 0111 (i.e., decimal 7, that is, SL₃=7). Thus, in combination with the SAM, this message would indicate that the receiver received a sequence of data blocks wherein the first 3 blocks in the sequence were invalid (because the first SAM bit is 0), the next 9 blocks in the sequence were valid (because the second SAM bit is 1), and the next 7 blocks in the sequence were invalid (because the third SAM bit is 0).

It is recognized in connection with the preferred embodiments that while the Cumulative ACK ARQ format has benefits in reporting upon certain data block sequences, it may provide certain drawbacks due to latency of communications between the base station and a subscriber/mobile station and thus it may be improved upon as detailed later. By way of example at this point, note that in some wireless protocols, such as in the above-introduced WiMAX standard, a subscriber/mobile station may not instantaneously communicate a service flow with the base station, but instead the subscriber/mobile station must request bandwidth from the base station and only upon receipt from the base station of such bandwidth, sometimes referred to as a reservation, is the mobile station permitted to then communicate one or more packets. In this regard, therefore, if a subscriber/mobile station desires to communicate a Cumulative ACK feedback message to a base station, then by the time the subscriber/mobile station is granted a reservation and thereafter communicates a Cumulative ACK feedback message, there has been a latency since the time that the base station transmitted the packets to which the later-received Cumulative ACK feedback message corresponds. Thus, there is the possibility, if not likelihood, that the base station has, before receiving the Cumulative ACK feedback message, already transmitted additional packets that are not comprehended by the later-received Cumulative ACK feedback message. As demonstrated later, therefore, when the base station receives and processes the latent feedback message, the base station may in response and improperly re-transmit packets to the mobile station that were not necessarily received in error, that is, the base station may re-transmit such packets that in fact were validly received and therefore did not require re-transmission. Thus, additional bandwidth is utilized in the re-transmission, as possibly are resources of the transmitting base station.

It is further recognized in connection with the preferred embodiments that the latency described above may also cause drawbacks with other ARQ formats or indeed in other standards. For example, recall that the Cumulative with Selective ACK ARQ format provides feedback from a receiving station that includes not only an identifier of the last valid data block but also one or more bitmaps corresponding to one or more respective groups of blocks of data; however, note that a given bitmap, while capable in its number of bits of characterizing a respective number of data blocks, may be formed by a receiving station at a time when not all of those blocks are ready to characterize. For example, assume in a given instance that a receiving station has received a given invalid data block followed by an additional six data blocks, while the 16 bit bitmap of the Cumulative with Selective ACK ARQ format would permit the receiving station to characterize a full 16 data blocks rather than just the six blocks that followed the invalid data block. Thus, in one approach the receiving station may simply provide a 16 bit bitmap that characterizes the 6 data blocks with the first 6 respective bits of the 16 bit bitmap, while then setting the remaining 10 bits of the 16 bit bitmap to invalid, even though in fact the remaining 10 data blocks corresponding to those remaining 10 bits may not yet have been received or may not be accurately characterized by the ARQ message; in this case, when the transmitting station receives this ARQ message, in response thereto it may well re-transmit the last 10 data blocks having interpreted the ARQ message to indicate that such blocks were not validly received. Alternatively, in one variation to the standard, the receiving station may in effect “back up” in the sequence of data blocks so as to fully characterize 16 received data blocks, that is, in the example above, instead of starting the Cumulative with Selective ACK ARQ message with an identification of the given invalid data block, instead the receiving station, with knowledge that it will characterize a total of 17 data blocks (one by sequence number and 16 by a 16-bit a bit map), backs up a total of 17 blocks in the received sequence so that the 17^{th} most-recently received block will be indicated in the ARQ message as valid instead of invalid, and the remaining 16 data blocks are characterized by the respective 16 bits in the ARQ message 16-bit bitmap—thus, this change effectively changes the earlier standard definition wherein the sequence indicator was always of an invalid data block, and instead contemplates the sequence indicator to identify a valid data block. In addition to requiring a change in the standard definition, this approach also requires overhead directed to addressing the “back up” described above.

Given the preceding, the preferred embodiments seek to improve upon the prior art, as demonstrated below.

### BRIEF SUMMARY OF THE INVENTION

In a preferred embodiment, there is a method of performing wireless communications. The method receives at a receiving unit a sequence of data blocks from a transmitting unit. The method also identifies at the receiving unit a first invalid sequential data block in the sequence. The method also communicates from the receiving unit a wireless message to the transmitting unit for provoking the transmitting unit to re-transmit a portion of the sequence of data blocks. The wireless message comprises a first field and a second field. The first field is for identifying the first invalid sequential data block. The second field is for identifying a last data block, from the sequence of data blocks, to which the wireless message applies.

Other aspects are also disclosed and claimed.

### BRIEF DESCRIPTION OF THE SEVERAL VIEWS OF THE DRAWING

FIG. 1 is an electrical diagram, in block form, of a wireless broadband metro area network into which the preferred embodiments may be implemented by way of example.

FIG. 2 is an electrical diagram, in block form, of a base station or subscriber station in the network of FIG. 2, constructed according to the preferred embodiment of the invention.

FIG. 3 illustrates a block diagram of an example of a sequence of communications between a base station (e.g., base station BS in FIG. 1) and various subscriber stations (e.g., SS subscriber stations in FIG. 1).

FIG. 4 illustrates a sequence of blocks communicated during three frames.

FIG. 5 illustrates a Cumulative ACK ARQ feedback message ARQ_{I} according to the preferred embodiments.

FIG. 6 illustrates a sequence of blocks communicated during three frames and wherein block B₈ is received as invalid.

FIG. 7 illustrates a sequence of blocks communicated during three frames and wherein block B₆ is received as invalid.

FIG. 8 illustrates a sequence of blocks communicated during three frames and wherein blocks B₄ through B₆ are received as invalid.

### DETAILED DESCRIPTION OF THE INVENTION

The preferred embodiments are described in connection with a preferred implementation into a base station and subscriber/mobile station in a “WiMAX” wireless broadband network, operating under the IEEE 802.16 standard, as it is contemplated that this implementation is especially beneficial when realized in such an environment. However, it is also contemplated that other preferred embodiments may be created to provide similar important benefits in other types of networks, particularly those in which an ARQ format is established with a transmitting station that re-transmits data blocks upon receipt of an ARQ message from a receiving station, wherein that message is delayed in time such that by the time the transmitting station receives the ARQ message it has transmitted to the same receiving station additional data blocks beyond those contemplated in the message. Accordingly, it is to be understood that the following description is provided by way of example only, and is not intended to limit the true inventive scope as claimed.

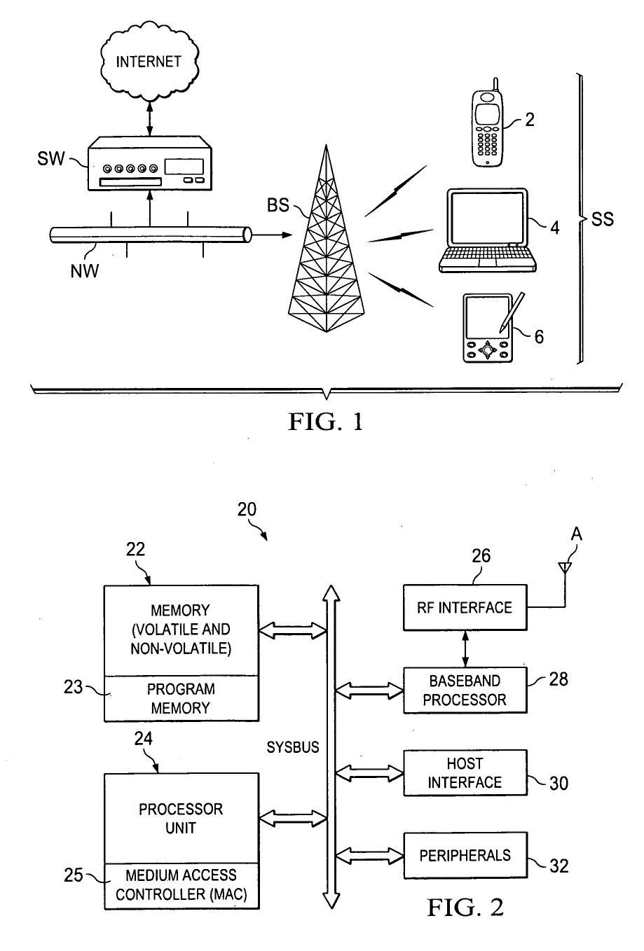

FIG. 1 illustrates a wireless metro area network (MAN) into which the preferred embodiments are implemented. In the network of FIG. 1, a base station BS corresponds to infrastructure at a fixed location, including an antenna and communication circuitry. Communications occur between base station BS and various mobile stations or subscriber stations SS in the vicinity of base station BS, and for sake of simplicity, while such stations are potentially mobile such stations are hereafter referred to as subscriber stations. It is contemplated, in the MAN context as illustrated in FIG. 1, that wireless communications between base station BS and subscriber stations SS can be carried over distances ranging up to several miles. The particular performance and distance over which such communications can be carried out will vary, of course, with atmospheric conditions and with the nature of various attenuators (e.g., buildings, mountains) in the vicinity of base station BS.

As noted above and as evident from FIG. 1, base station BS includes an antenna tower or other antenna structure suitable for supporting communications over its coverage area. Base station BS also includes circuitry (not shown) and other support equipment suitable for communicating over backbone network NW into a wide area network (WAN) context. The example of FIG. 1 illustrates switch equipment SW as residing on backbone network NW, through which base station BS is able to communicate to and from the global Internet and with various other devices and network elements coupled to the Internet, via Internet Protocol (IP) communications and the like.

In the example of FIG. 1, it is contemplated that many types of subscriber stations SS may communicate over the wireless MAN supported by base station BS. A smartphone 2 is one example of subscriber station SS, and in this example includes not only cellular telephone connectivity, but also circuitry for connecting to the wireless MAN supported by base station BS; in this manner, smartphone 2 can operate using such communications services as Internet web browsing, the sending and receipt of email messages, and other services such as Voice over Internet Protocol (VoIP) telephony. It is contemplated that smartphone 2 is thus capable of both cellular and wireless broadband communications, and supporting services such as those contemplated according to so-called “3G” or “LTE” (Long Term Evolution) wireless services. Another type of subscriber station SS that may communicate in the network of FIG. 1 is illustrated by a laptop computer 4, by way of a WiMAX or wireless broadband network adapter; laptop computer 4 of course includes the circuitry, display, and software capability for carrying out services such as Internet web browsing, email communications, and VoIP telephony and the like. Similarly, a personal digital assistant (PDA) 6 in FIG. 1 represents handheld wireless broadband capable devices, including not only PDAs but also palmtop or tablet computers, and the like, such devices also supporting the services contemplated in connection with wireless broadband connectivity.

FIG. 2 illustrates the construction of network station 20 according to a preferred embodiment. This generalized construction of network station 20 as shown in FIG. 2 is contemplated to be applicable to either base station BS or to subscriber station SS, such as smartphone 2, laptop computer 4, PDA 6, or a wireless broadband adapter or function within such subscriber station devices. In this context, therefore, network station 20 may be representative of the entire device or system, or instead of only an adapter, card, or particular built-in or added function in base station BS or such subscriber station SS. Furthermore, those skilled in the art having reference to this specification will understand that the architecture illustrated in FIG. 2 is presented by way of example only, and that many variations to this architecture alternatively may be used to realize network station 20.

Network station 20 is contemplated to be implemented by way of a programmable digital computing system. As such, network station 20 includes a processor unit 24, which may be implemented as a general purpose or application-specific processor, as determined by the system designer, capable of executing instructions in computer programs to carry out the overall processing and functionality of network station 20. In FIG. 2, network station 20 also includes memory 22, preferably including both volatile random access memory (RAM) and also non-volatile memory, for example read-only memory (ROM), flash memory, or some other type of programmable non-volatile memory. It is contemplated that at least a portion of memory 22 constitutes program memory 23, for storing instruction sequences or software routines that are executable by processor unit 24 in its operation. Typically, program memory 23 will be realized by non-volatile memory within memory 22 in one way or another, in which case the program instructions may be fetched from such non-volatile memory within memory 22 serving as program memory. Alternatively, some sort of boot-loading or other software management function may be executed on startup of network station 20, so that the program instructions (and thus program memory 23) are deployed at least in part into volatile memory within memory 22. Of course, the various portions of memory 22 (data memory and program memory; volatile and non-volatile memory; etc.) may be realized in the same memory address space or in different memory address spaces, according to the particular architecture. In the example of FIG. 2, processor unit 24 accesses memory 22 via system bus SYSBUS. A portion of processor unit 24 in network station 20 according to the preferred embodiments is shown in FIG. 2 as corresponding to medium access controller (MAC) 25. MAC controller 25 may be a separate integrated circuit, or separate processor core, within processor unit 24, or alternatively may be realized by the same processor core of processor unit 24 used to perform various data processing functions within network station 20.

According to a preferred embodiment, a methodology is provided whereby a receiving station (e.g., one of base station BS or any subscriber station SS) receives a sequence of data blocks (or referred to as packets) from a transmitting station (e.g., also one of base station BS or any subscriber station SS), the receiving station sends an ARQ message back to the transmitting station, and the transmitting station decodes the ARQ message and responds thereto. It is contemplated that various processing circuitry in network station 20 may accomplish this methodology as either the receiving station or the transmitting station by the use of program instructions. Thus, such program instructions may be executed by a MAC controller 25 or such other processing circuitry in network station 20, and in doing so carries out the operations of the preferred embodiments as described later. In this regard, it is contemplated that such program instructions or a portion thereof may be provided to network station 20 by way of computer-readable media, or otherwise stored in program memory 23 such as by way programming program memory 23 during or after manufacture, or provided by way of other conventional optical, magnetic, or other storage resources at those computer resources, or communicated to network station 20 by way of an electromagnetic carrier signal upon which functional descriptive material corresponding to that computer program or portion thereof is encoded.

Other system functions in network station include peripherals 32, shown in FIG. 2 as coupled to system bus SYSBUS, for example including input/output functions such as one or more serial ports, timer circuitry, and the like, as suitable for the particular function of network station 20. Host interface 30 is coupled to system bus SYSBUS, and serves as an interface to a host computer or other system. Host interface 30 is particularly useful if network station 20 is implemented as an adapter to a larger system, such as in the case of base station BS or laptop computer 4. In that case, the adapter of network station 20 would communicate with the host system by way of this host interface 30.

Network station 20 also includes the appropriate circuitry for communicating in a wireless broadband network such as that shown in FIG. 2. In this arrangement, a baseband processor 28, coupled to system bus SYSBUS, may be realized by a digital signal processor or other programmable logic and performs the appropriate encoding and decoding operations, digital filtering, modulation and demodulation, as useful and appropriate for the physical layer requirements of the wireless communications protocol supported by network station 20. An RF interface 26 in network station 20 is preferably realized by the appropriate digital and analog circuitry for driving radio frequency (RF) signals being transmitted, and for receiving RF signals, via antenna A. RF interface 26 communicates with baseband processor 28.

As introduced earlier, according to a preferred embodiment, network station 20 is programmed, for example by way of instructions stored in program memory 23 and executable by MAC controller 25, to perform different operations when either:

(1) acting as a receiving station, it:
(i) receives a sequence of data blocks; and
(ii) transmits in response an ARQ message back to the transmitting station that transmitted those data blocks; or

(2) acting as a transmitting station, it:
(i) transmits a sequence of data blocks;
(ii) in response receives, from the receiving station, an ARQ message that indicates to the transmitting station the need to re-transmit a portion (or all) of the transmitted sequence of data blocks; and
(iii) decodes the ARQ message and re-transmits the portion, if any, of the already-transmitted sequence based on the indication of the ARQ message.
   These aspects as either a receiving station or a transmitting station are detailed below.

In the preferred embodiments, in acting as a receiving station, network station 20 may operate according to any of known methodologies and per known protocols to receive a sequence of data blocks, and then the ARQ response also may be performed in known manners, including those set forth in the IEEE 802-16 formats detailed earlier in this document. Thus, by ways of example, the ARQ response may be any one of (i) Selective ACK; (ii) Cumulative ACK; (iii) Cumulative with Selective ACK; and (iv) Cumulative ACK with Block Sequence ACK. However, attention is directed to the second and third of those options, that is, the Cumulative ACK, for sake of better understanding a beneficial example of the inventive scope is shown for the Cumulative ACK; however, the preferred embodiment is also contemplated as implemented into the Cumulative with Selective ACK and one skilled in the art may appreciate the possible implementation and response to still other ARQ formats. Further, also per the preferred embodiments, when network station 20 operates to transmit a Cumulative ACK (or Cumulative with Selective ACK), it may do so using a novel encoding approach that is also treated in a novel manner by the corresponding receiving station, as further detailed below.

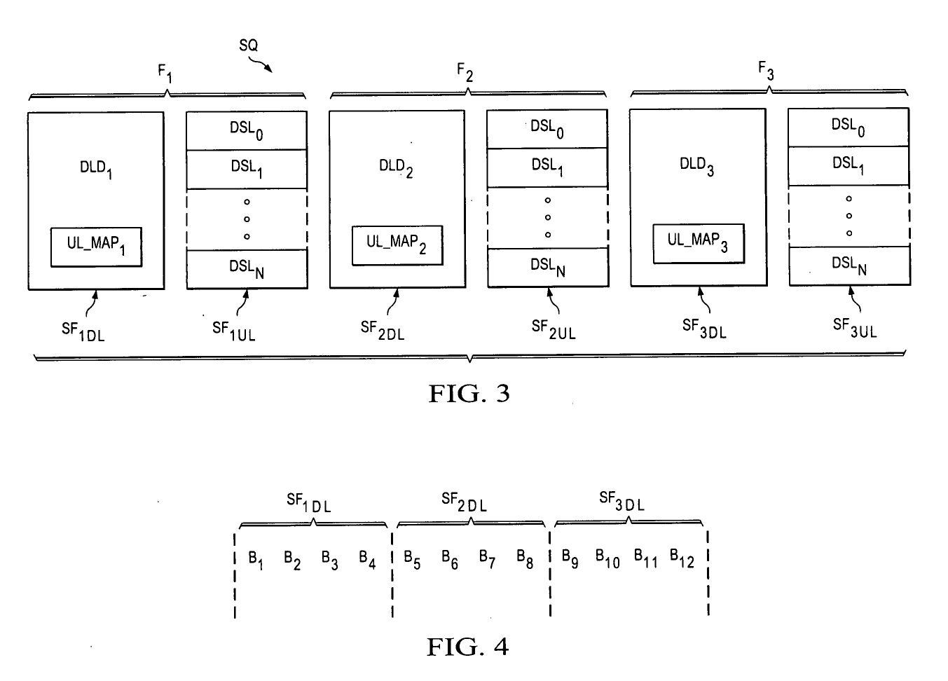

FIG. 3 illustrates a block diagram of an example of a sequence of communications between a base station (e.g., base station BS in FIG. 1) and various subscriber stations (e.g., SS subscriber stations in FIG. 1). The illustrated sequence generally is intended to indicate time from left to right and includes three frames F₁, F₂, F₃ of data. Each frame Fₓ is divided into two sub-frames, with the first sub-frame being a downlink sub-frame, meaning a communication from the base station to the various subscriber stations, and the second sub-frame being an uplink sub-frame, meaning a communication from various of the subscriber stations to the base station. For sake of convention, each sub-frame is designated as “SF” with a subscript that identifies the a number of the corresponding frame and an indication of whether the sub-frame is a downlink sub-frame (i.e., subscript includes DL) or an uplink sub-frame (i.e., subscript includes UL); thus, by example, frame F₁ includes a first sub-frame SF_{1DL} that is a downlink sub-frame and a second sub-frame SF_{1UL} that is an uplink sub-frame.

Each downlink sub-frame SF_{xDL} includes downlink data DLDₓ and also an uplink map UL_MAPₓ. With respect to the uplink map, recall from earlier that in certain protocols a subscriber station must request bandwidth from the base station and only upon receipt from the base station of such bandwidth (i.e., of a “reservation”) is the subscriber station permitted to then communicate one or more data blocks. In this regard, each uplink map UL_MAPₓ of FIG. 3 is intended to depict a portion of data in the uplink sub-frame that includes reservations granted to subscriber stations that upon receipt thereof are thereby granted bandwidth to communicate in a later uplink sub-frame. For example in FIGS. 3 and 1, therefore, upload map UL_MAP₁ may grant a reservation to smartphone 2 (or some other subscriber station), so that smartphone 2 may then communicate data in uplink sub-frame SF_{1UL} (or a later sub-frame).

Each uplink sub-frame SF_{xUL} includes a number N+1 of data slots or is otherwise partitioned to represent data from different subscriber stations that are communicated during the time allotted to the uplink sub-frame. For example, each data slot may correspond to a different frequency (or set of frequency hops) and a corresponding subscriber station therefore communicates along that frequency during the uplink sub-frame. For example in FIGS. 3 and 1, therefore, during uplink sub-frame SF_{1UL}, smartphone 2 may communicate corresponding to data slot DSL₀, while at the same time laptop computer 4 may communicate corresponding to data slot DSL₁, while at the same time PDA 6 may communicate corresponding to data slot DSL_{N}, with still other subscriber stations (not shown) communicating at the same time in correspondence with any other respective and available data slots in uplink sub-frame SF_{1UL}. Typically the communications of data blocks in a data slot are referred to as packets or data groups. Moreover, the maximum number of unacknowledged packets communicated from a transmitting station to a receiving station is typically referred to as a window, and that window may span multiple frames. For example, assume that smartphone 2 has a window of nine packets to communicate to base station BS; thus, smartphone 2 may communicate three packets during uplink sub-frame SF_{1UL}, three packets during uplink sub-frame SF_{2UL}, and three packets during uplink sub-frame SF_{3UL}, thereby concluding the total of nine packets. The actual length of a window is typically negotiated during setup of a connection between the base station and subscriber station and may depend on various factors such as data traffic and available device resources.

It has been observed in connection with the prior art and as improved upon by the preferred embodiments that certain operations pose limitations in connection with communications between a base station and subscriber station, as may be now more apparent given the context provided above. Specifically, note that a base (or other transmitting) station typically stores an entire window of packets and maintains that data even after transmitting all of it until the base station is satisfactorily informed that the receiving subscriber station has received all of those packets as valid data. Indeed, often the transmitting base station will stall, that is, it will not communicate additional data, until it is notified that the window of data was validly received. In order to avoid excessive stalls and the inefficiencies arising from them, there is an incentive or goal for the receiving subscriber station to respond with an ARQ feedback message before the transmitting base station has reached the end of its window, that is, so that hopefully the transmitting base station can be informed, via ARQ feedback, that at least a portion of the window was validly received before having to stall after transmitting the entirety of the window, and with that information the transmitting station need not retain at least a copy of that window data of which it is informed was validly received. If this process continues effectively, then the chance of a stall occurring while having to store an entire data window is reduced.

Another observed limitation of the above-described communications is the latency that arises, and how it impacts ARQ communications, in the sequence of communications in FIG. 3 and specifically from the reservations granted in each upload map UL_MAPₓ. This latency is illustrated by a simplified example of a packet sequence in FIG. 4, as follows. Assume that base station BS and smartphone 2 have negotiated a window of 12 blocks B₁ through B₁₂ and assume additionally that base station BS then communicates those blocks as 4 blocks per frame as follows. In frame F₁ (specifically downlink sub-frame SF_{1DL}), base station BS transmits blocks B₁, B₂, B₃, and B₄, as shown in FIG. 4, and subscriber station smartphone 2 receives those blocks B₁, B₂, B₃, and B₄. In frame F₂ (specifically downlink sub-frame SF_{2DL}), base station BS transmits blocks B₅, B₆, B₇, and B₈, as shown in FIG. 4, and subscriber station smartphone 2 receives those blocks B₅, B₆, B₇, and B₈. Assume also that smartphone 2 schedules an ARQ feedback message to indicate that it has received blocks B₁ through B₈, and in uplink sub-frame SF_{2UL} smartphone 2 requests bandwidth (i.e., a reservation) so that it can communicate this ARQ feedback message to the base station. In frame F₃ (specifically downlink sub-frame SF_{3DL}), base station BS transmits, and smartphone 2 thereby receives, blocks B₉, B₁₀, B₁₁, and B₁₂, as shown in FIG. 4, and it also grants a reservation to smartphone 2 in uplink map UL_MAP₃; next, in uplink sub-frame SF_{3UL}, smartphone 2 sends the previously-created ARQ feedback message to base station BS, indicating the validity only of blocks B₁ through B₈, while not yet providing information about or characterizing the validity, or lack thereof, of blocks B₉, B₁₀, B₁₁, and B₁₂. Thus, base station BS receives the ARQ feedback message indicating the validity of blocks B₁ through B₈. Next, in frame F₄ (not shown in the Figure), the base station may assume since the ARQ message only characterized blocks B₁ through B₈ that the other blocks it sent to the same subscriber station, namely blocks B₉ through B₁₂, were received as invalid data; thus, in frame F₄, base station BS may re-transmit those latter blocks B₉ through B₁₂, even though it may well be that such blocks were validly received. In other words, due to the latency of the subscriber station having created an ARQ message but then having to wait to transmit that message to base station BS while base station BS was transmitting additional blocks to the same subscriber station, by time base station BS thereafter receives the ARQ feedback message that message is stale in that it does not describe all data blocks that upon receipt of the ARQ message have been communicated from base station BS to that subscriber station. Moreover, this staleness may cause base station BS to unnecessarily re-transmit a portion of the window (i.e., blocks B₉ through B₁₂). Still further, this example describes a problem when the base station BS grants a reservation that permits uplink in the very next frame following the reservation request, while in fact this problem may be exacerbated if the base station BS grants the reservation more than one frame later while in the interim it has transmitted additional blocks to the same reservation-requesting subscriber station, as the base station may as a result re-transmit all blocks that were originally transmitted during that interim even if some (or all) of those blocks were validly received by the subscriber station in an earlier transmission.

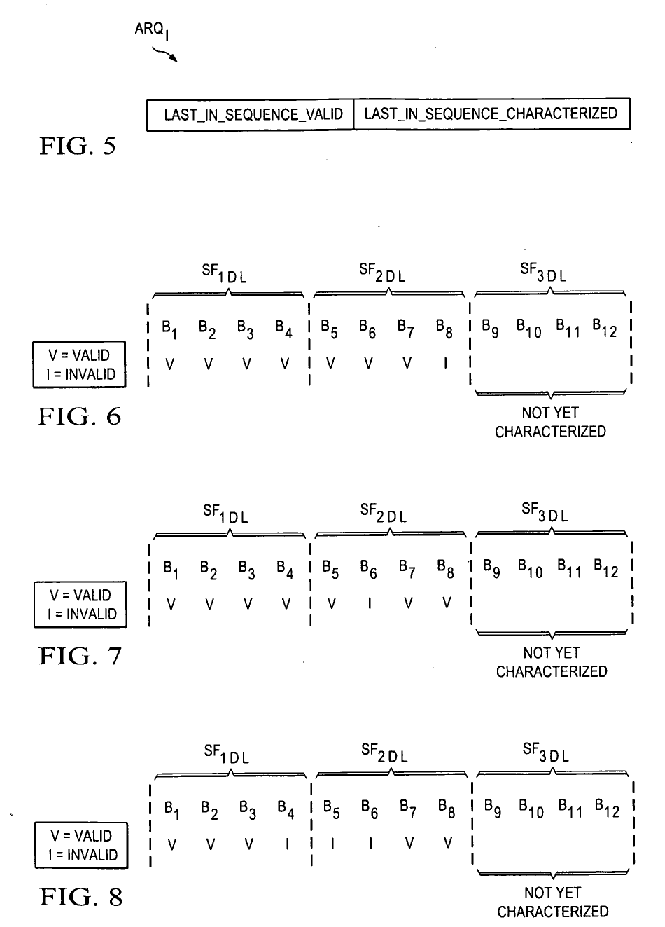

FIG. 5 illustrates an inventive Cumulative ACK ARQ feedback message ARQ_{I} according to the preferred embodiments and that may be communicated by a subscriber station to a base station such as detailed in the earlier discussion. Note that in a preferred embodiment directed to the WiMAX standard as introduced above, generally the ACK ARQ feedback message ARQ_{I} is presented from subscriber station to base station; however, in other wireless communication protocols there may be a need and benefit for such a message to be presented in either direction between, or the direction from, the base station to the subscriber station. In any event, in the example provided herein, the illustrated example message ARQ_{I} includes only two indicators (i.e., information fields), where in alternative embodiments other fields may be included as well, or one or more indicators from message ARQ_{I} may be included in other types of ARQ messages. Indeed and as noted earlier, the preferred embodiment as now shown with the two indicators of FIG. 5 also may be included as part of a Cumulative with Selective ACK. In any event, each of the two indicators of message ARQ_{I} is described below.

A first indicator in message ARQ_{I} includes a LAST_IN_SEQUENCE_VALID indicator. This indicator is included in a Cumulative ACK ARQ message (or Cumulative with Selective ACK ARQ message) according to the prior art. For example, under the IEEE 802.16 (WiMAX) standard this indicator is referred to as the ‘sequence number of the last successfully received block’, and as that phrase describes, the LAST_IN_SEQUENCE_VALID indicator identifies the last validly received block number for a sequence of blocks, which in essence therefore also necessarily is for implicitly identifying the first invalid block which immediately follow the last validly received block in the sequence. To further appreciate this indicator, consider now the block sequence in FIG. 6, which is the same as that in FIG. 4, but now indicates by way of example which block in the sequence is first received as invalid, as shown by the legend below the blocks. In the example, blocks B₁ through B₇ are received by a subscriber station as valid, while block B₈ is received by the subscriber station as invalid. Assume also that once the subscriber station has received these blocks, it creates a Cumulative feedback message such as feedback ARQ_{I} in FIG. 5, although after the creation blocks B₈ through B₁₂ also may be received by that station, such as in a manner comparable to the earlier example where the subscriber station is ready to characterize one set of blocks (e.g., blocks B₁ through B₈) and receives additional ones while awaiting a reservation from a base station. In any event, therefore, when the receiving subscriber station creates its Cumulative feedback message such as feedback ARQ_{I} in FIG. 5, it will identify block B₇ via the LAST_IN_SEQUENCE_VALID indicator, because block B₇ was the last validly received block, that is, the block which immediately in the sequence preceded the first invalid block B₈.

As detailed earlier, if in the prior art a feedback ARQ message is received by a transmitting base station after sufficient latency, then the base station may needlessly re-transmit all blocks following the LAST_IN_SEQUENCE_VALID block from the data window that applies to that ARQ message; to correct this inefficiency, and as shown in FIG. 5, in the preferred embodiment the feedback ARQ message further includes a LAST_IN_SEQUENCE_CHARACTERIZED indicator. This indicator provides a representation or explicit identifier of the end of the sequence that is being characterized by the corresponding ARQ message ARQ_{I}, which is now further explained including by way of examples. Looking again to the example of blocks in FIG. 6, assume again that a receiving subscriber station is to formulate a Cumulative feedback ARQ message at some point after receiving frame F₂, that is, after having received blocks B₁ through B₈. As indicated above, because block B₈ is invalid, the receiving subscriber station provides an indication that block B₇ was the LAST_IN_SEQUENCE_VALID. Per the preferred embodiment, in addition the receiving subscriber station provides an indication in the ARQ message that block B₈ is the last packet in the sequence that is being characterized by the receiving subscriber station in that particular ARQ message. In other words, because the receiving subscriber station at that point in time is only endeavoring to characterize received blocks B₁ through B₈, then the receiving subscriber station is not in its ARQ message characterizing or providing any indication that applies to any block that might follow block B₈, such as blocks B₉ through B₁₂. Thus, in the present example, the receiving subscriber station provides an indication of block B₈ in the LAST_IN_SEQUENCE_CHARACTERIZED indicator, and the methodology facilitated by this indicator is described below.

Continuing with the example of the sequence in FIG. 6 and with the indicators in feedback message ARQ_{I} of FIG. 5 based on that example, note now the preferred embodiment methodology of operation in response to that feedback message. Specifically, once the subscriber station that created message ARQ_{I} is granted a reservation (i.e., communication bandwidth) to communicate with the corresponding base station, then it transmits feedback message ARQ_{I} to the base station. In response to feedback message ARQ_{I}, the base station is informed that block B₇ is the last block that was validly received by the subscriber station, and in addition however the base station is informed in the feedback message ARQ_{I} that the message is characterizing the validity or invalidity of data only up to block B₈ in the window of blocks that it has communicated to the subscriber station. Thus, at or after this point in time, the base station re-transmits only any block following the last valid block and stopping with the last characterized block as indicated in the LAST_IN_SEQUENCE_CHARACTERIZED indicator, so in the present example only block B₈ is re-transmitted. Thus, this result may be contrasted with the comparable prior art example set forth above, wherein the base station not only re-transmitted block B₈, but it continued to re-transmit all remaining blocks in the window (e.g., up to and including block B₁₂). Accordingly, per the preferred embodiment, and based on the length of the data window and the location of the block indicated in the LAST_IN_SEQUENCE_VALID, then a considerable number of blocks may be spared from re-transmission as compared to the prior art. For example, consider a more extreme example wherein a window spans 512 blocks, and assume under the prior art that the first block therein is received as invalid, yet due to latency the resulting ARQ message is later received by the base station that transmitted that window; in that case, the base station may re-transmit the entirety of the 512 blocks. In contrast, according to the preferred embodiment, the LAST_IN_SEQUENCE_CHARACTERIZED indicator may indicate any block before the end of the window, or even in the most conservative case may indicate that first invalid block, in which case the base station does not re-transmit the remaining 511 blocks of the data window.

To further illustrate additional inventive aspects, FIG. 7 again illustrates the example sequence of blocks from FIG. 4, where the subscriber station has received blocks B₁ through B₈ in the sequence and desires to characterize those blocks at a given time (e.g., blocks B₉ through B₁₂ are not yet received, or the receiving station is not prepared to characterize them in a feedback message, or the receiving station receives them after it has characterized blocks B₁ through B₈ in an ARQ message). In the example of FIG. 7 and as shown by the legend below the blocks, block B₆ is the first in the entire sequence that is received by the subscriber station as invalid. Thus, per the preferred embodiment, the receiving subscriber station identifies in its feedback message ARQ_{I} block B₅ as the LAST_IN_SEQUENCE_VALID. In the present example, however, note that the receiving subscriber station nonetheless has received all blocks in frame F₂ and desires to characterize those blocks up to and ending on a frame boundary, that is, up through block B₈. Thus, in one embodiment, the receiving subscriber station indicates in the corresponding feedback message ARQ_{I}, and particularly as the LAST_IN_SEQUENCE_CHARACTERIZED indicator, the last block of the received frame, so in the present example it would so indicate block B₈. In this case, therefore, the base station upon receipt of and in response to the feedback message may indeed re-transmit up to that indicated block B₈, thereby re-transmitting some blocks following the first invalid packet, that is, in the present example it could re-transmit blocks B₇ and B₈ (in addition to block B₆), but in this approach there is the simplification that the LAST_IN_SEQUENCE_CHARACTERIZED indicator has a frame boundary. Moreover, therefore, any re-transmission by the transmitting station in response to the message ARQ_{I} is thereby limited to the frame boundary indicated by the LAST_IN_SEQUENCE_CHARACTERIZED indicator. Thus, in the present example, where the base station has already transmitted blocks B₉ through B₁₂ as shown in FIG. 7, the base station will not re-transmit those latter blocks in response to message ARQ_{I} (although it could be called upon to re-transmit those blocks in response to a later ARQ message).

In an alternative embodiment, the receiving subscriber station identifies in the LAST_IN_SEQUENCE_CHARACTERIZED indicator a block that is not necessarily the last in a received frame. For example, such an approach may be preferable when or if the ARQ frequency differs from the frame frequency. In this alternative embodiment, the receiving subscriber station identifies in the LAST_IN_SEQUENCE_CHARACTERIZED indicator the last successive invalid block in the window sequence that follows the LAST_IN_SEQUENCE_VALID block, where the identified block is not necessarily the last block before the end of a frame boundary. For example, again in FIG. 7 for which the LAST_IN_SEQUENCE_VALID indicator identifies block B₅, then there is only one successive invalid block (i.e., block B₆) in blocks B₁ through B₈; in the alternative embodiment, therefore, the receiving subscriber station identifies this last characterized block B₆, which is received in the middle of a frame, in the LAST_IN_SEQUENCE_CHARACTERIZED indicator. And, as a result, when the feedback message ARQ_{I} is received by the base station, it will not re-transmit beyond block B₆ in response to that feedback message. Thus, in the present example, where the base station has already transmitted blocks B₇ through B₁₂ as shown in FIG. 7, the base station will not re-transmit those latter blocks in response to message ARQ_{I} (although it could be called upon to re-transmit those blocks in response to a later ARQ message). Instead, therefore, the base station only re-transmits block B₆ in response to message ARQ_{I}.

Next, consider again the above-described alternative embodiment but now for the example sequence of blocks in FIG. 8. As in the above example, the ACK frequency does not match the frame boundary. In this case and as shown by the legend, blocks B₄, B₅, and B₆ are all invalid. Thus, the receiving subscriber station identifies block B₃ in the LAST_IN_SEQUENCE_VALID indicator of the message ARQ_{I}, but note there is a sequence of three successive invalid blocks (i.e., blocks B₄, B₅, and B₆) following that last valid block (i.e., block B₃). Thus, in this alternative embodiment, the receiving subscriber station identifies the last of those successive invalid blocks, which is block B₆ in the example, in the LAST_IN_SEQUENCE_CHARACTERIZED indicator of the message ARQ_{I}. Next and as a result, note the operation of the base station in response to receiving and responding to the feedback message ARQ_{I}. Specifically, in response to that message, the base station is informed that block B₃ was the last validly received packet, so the base station again performs a re-transmission of the window blocks starting at the packet following that identified by LAST_IN_SEQUENCE_VALID and continuing to and concluding with the packet identified by the LAST_IN_SEQUENCE_CHARACTERIZED indicator; thus, in the present example, the base station re-transmits blocks B₄, B₅, and B₆, but then stops its re-transmission to that corresponding subscriber station until receiving an additional ARQ message therefrom.

From the preceding, it may be appreciated that the preferred embodiments provide a method and apparatus for automatic repeat requests (ARQ) from a receiving unit to indicate to a transmitter to re-transmit a number of data units that were not properly received by the receiving unit. The ARQ of the preferred embodiments may be used in addition to other ARQ methodologies to provide considerable and additional flexibility over the prior art. In a WiMAX network, such an approach will be especially useful if there are burst errors in acknowledging a larger number of blocks/packets with lower feedback bandwidth. Thus, these considerations and the described embodiments also demonstrate that while the present embodiments have been described in detail, various substitutions, modifications or alterations could be made to the descriptions set forth above without departing from the inventive scope, as is defined by the following claims.

1. A method of performing wireless communications, comprising:
receiving at a receiving unit a sequence of data blocks from a transmitting unit;
first, identifying at the receiving unit a first invalid sequential data block in the sequence;
second, communicating from the receiving unit a wireless message to the transmitting unit for provoking the transmitting unit to re-transmit a portion of the sequence of data blocks, the wireless message comprising:
a first field for identifying the first invalid sequential data block; and
a second field for identifying a last data block, from the sequence of data blocks, to which the wireless message applies.

2. The method of claim 1 wherein the first field is for identifying the first invalid sequential data block by providing an indicator of a last valid data block that immediately precedes the first invalid sequential data block in the sequence.

3. The method of claim 1:
wherein the sequence of data blocks are received in a plurality of frames; and
wherein the second field identifies an end of a frame in the plurality of frames.

4. The method of claim 3 and further comprising operating the transmitting unit to re-transmit a number of data blocks starting from a first invalid data block identified by the first field and concluding with the data block identified by the second field.

5. The method of claim 1 wherein the second indicator identifies a last successive invalid data block in a plurality of invalid data blocks in the sequence that follows the data block identified by the first field.

6. The method of claim 5 and further comprising operating the transmitting unit to re-transmit a number of data blocks starting from the data block identified by the first field and concluding with the data block identified by the second field.

7. The method of claim 1:
wherein the sequence of data blocks are received in a plurality of frames; and
wherein the second field identifies a last data block in a location in the frame other than an end of a frame in the plurality of frames.

8. The method of claim 1 and further comprising, between the first and second steps, communicating from the receiving unit a request message to the transmitting unit for requesting from the transmitting unit authority to transmit the wireless message.

9. The method of claim 1:
wherein communications from the transmitting unit to the receiving unit are in a plurality of frames; and
wherein the second step communicates the wireless message in a frame immediately following a frame that includes the request message.

10. The method of claim 1:
wherein communications from the transmitting unit to the receiving unit are in a plurality of frames; and
wherein the second step communicates the wireless message in a frame more than one frame after a frame that includes the request message.

11. The method of claim 1 and further comprising, between the first and second steps, the steps of:
receiving at the receiving unit additional data blocks; and
excluding a validity indicator relating to the additional data blocks from the wireless message.

12. The method of claim 1 wherein the wireless message further comprises one or more bitmaps corresponding to one or more respective blocks of data in the sequence of data blocks.

13. The method of claim 1 wherein the wireless message comprises a WiMAX message.

14. A wireless communications device, comprising:
circuitry for receiving a sequence of data blocks from a transmitting unit;
circuitry for identifying a first invalid sequential data block in the sequence;
circuitry for communicating a wireless message to the transmitting unit for provoking the transmitting unit to re-transmit a portion of the sequence of data blocks, the wireless message comprising:
a first field for identifying the first invalid sequential data block; and
a second field for identifying a last data block, from the sequence of data blocks, to which the wireless message applies.

15. The device of claim 14 wherein the first field is for identifying the first invalid sequential data block by providing an indicator of a last valid data block that immediately precedes the first invalid sequential data block in the sequence.

16. The device of claim 14:
wherein the sequence of data blocks are received in a plurality of frames; and
wherein the second field identifies an end of a frame in the plurality of frames.

17. The method of claim 14 wherein the second indicator identifies a last successive invalid data block in a plurality of invalid data blocks in the sequence that follows the data block identified by the first field.

18. The method of claim 14:
wherein the sequence of data blocks are received in a plurality of frames; and
wherein the second field identifies a last data block in a location in the frame other than an end of a frame in the plurality of frames.

19. The device of claim 14 and further comprising circuitry for communicating a request message to the transmitting unit for requesting from the transmitting unit authority to transmit the wireless message.

20. The device of claim 14 wherein the wireless message further comprises one or more bitmaps corresponding to one or more respective blocks of data in the sequence of data blocks.
